(19) United States
(12) Patent Application Publication
(10) Pub. No.: US 2011/0305888 A1
(43) Pub. Date: Dec. 15, 2011

(54) RECYCLING PROGRAM AND METHOD OF ENCOURAGING RECYCLING OF TARGET WASTE MATERIALS BY USE OF PRECIOUS METALS

(76) Inventor: Mike Lafebere, Manhattan, KS (US)

(21) Appl. No.: 13/217,800

(22) Filed: Aug. 25, 2011

Related U.S. Application Data
(62) Division of application No. 12/021,135, filed on Jan. 28, 2008.

(51) Int. Cl. B32B 3/14; C03C 14/00; D21H 17/67; A24D 1/04; C08K 3/08

(52) U.S. Cl. 428/209; 131/361; 524/440; 162/181.9; 501/32

(57) ABSTRACT

A recycling program provides a monetary incentive to encourage recycling of target waste materials, such as paper, glass and plastic products. A precious metal, such as gold, silver, platinum or palladium, is incorporated into the target waste material during manufacturing to provide an incentive for recycling the target material. A visual marking is placed on the target material to distinguish from other waste items that do not contain a precious metal. A deposit is collected from consumers when purchasing the target material, and the deposit is paid back when the target material is delivered to a recycling collection point. Recycling of the target material is encouraged by efforts to reclaim the precious metal.

### RELATED APPLICATIONS/DOCUMENTS

This application is a divisional application of Applicant's U.S. patent application Ser. No. 12/021,135 filed on Jan. 28, 2008. This application is related to the invention described in the Applicant's Disclosure Document No. 595067 filed in the U.S. Patent & Trademark Office on Feb. 15, 2006. The entire content of the Disclosure Document No. 595067 is incorporated herein by reference.

### BACKGROUND OF THE INVENTION

1. Field of the Invention

The present invention relates generally to methods of recycling and providing incentives for recycling. In particular, the present invention relates to a recycling program and method in which precious metals are incorporated into target waste materials during manufacture to provide an incentive for recycling the target material.

2. Description of the Related Art

Most cities and counties in the United States currently have some type of paper, plastic and/or glass recycling program. An example of a recycling program is described in U.S. Pat. No. 5,072,833 of Hansen et al.

There is an environmental incentive to have recycling programs because they reduce the amount of trash and debris on the streets and roadsides, and also reduce the amount of landfill space required to dispose of waste. However, these recycling programs often do not work as well as intended due to a lack of financial incentives to encourage consumers to participate in the recycling. As a result, our landfills still contain approximately 40% paper, 9% plastic, and 8% glass, all of which could be recycled to dramatically reduce the amount of landfill space required and its negative impact on the environment.

There are known processes for recovering precious metals from scrap materials. A variety of industries generate scrap materials that contain precious metals, including jewelry manufacturers, semiconductor producers, photographic processors, and metal plating operators. These scrap materials are typically sold to scrap processors who recover the precious metals from the scrap materials. U.S. Pat. No. 6,165,248 discloses a method for evaluating the precious metal content in a batch of such scrap materials.

There are also known processes for adding marker materials to a plastic composition to make the plastic identifiable to aid in sorting materials for recycling. For example, U.S. Pat. No. 5,201,921 discloses a process for identifying particular plastics for recycling by adding a fluorescent dye to the plastic material during manufacture.

There is a need for a more effective recycling program with financial incentives to encourage collection of the targeted waste materials.

### SUMMARY OF THE INVENTION

The present invention provides a recycling program with a monetary incentive to encourage recycling of target waste materials, such as paper, glass and plastic products. A precious metal, such as gold, silver, platinum or palladium, is incorporated into the target waste material during manufacturing to provide an incentive for recycling the target material. A visual marking is placed on the target material to distinguish from other waste items that do not contain a precious metal. A deposit is collected from consumers when purchasing the target material, and the deposit is paid back when the target material is delivered to a recycling collection point. Recycling of the target material is encouraged by efforts to reclaim the precious metal.

According to one aspect of the present invention, a method of encouraging recycling is provided, comprising: identifying a target waste material that does not normally contain a precious metal; incorporating a precious metal into the target material during manufacturing to provide an incentive for recycling the target material; and promoting recycling of the target material to reclaim the precious metal.

According to another aspect of the present invention, a recycling program is provided, comprising: identifying a target waste material that does not normally contain a precious metal; incorporating a precious metal into the target material during manufacturing in an amount sufficient to provide an incentive for recycling the target material; placing a visual marking on the target material to distinguish the target material from items that do not contain a precious metal; and promoting recycling of the target material to reclaim the precious metal.

Numerous other objects and advantages of the present invention will be apparent to those skilled in this art from the following description wherein there is shown and described embodiments of the present invention, simply by way of illustration of some of the modes best suited to carry out the invention. As will be realized, the invention is capable of other different embodiments, and its several details are capable of modification in various obvious aspects without departing from the invention. Accordingly, the drawings and description should be regarded as illustrative in nature and not restrictive.

### BRIEF DESCRIPTION OF THE DRAWINGS

The present invention will become more clearly appreciated as the disclosure of the present invention is made with reference to the accompanying drawings. In the drawings:

FIG. 1 is a diagram of a recycling program according to the present invention.

FIG. 2 is a flow chart of a recycling method according to the present invention.

FIG. 3 is a cross section view of a cigarette incorporating a precious metal element in the butt according to the present invention.

### DETAILED DESCRIPTION OF THE INVENTION

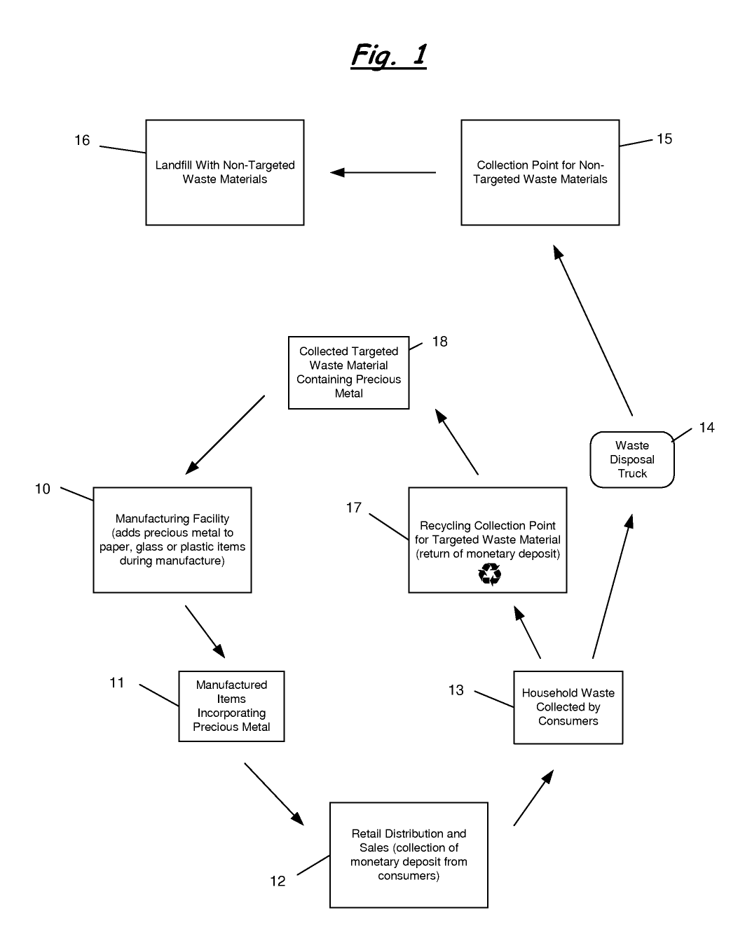

The present invention will now be described in detail with reference to FIGS. 1 to 3 of the accompanying drawings.

The present invention provides a recycling method that can be implemented to eliminate various types of trash and debris from the streets and grounds of our nation, and to recycle a larger percentage of these items that are currently being recycled.

The recycling program according to the present invention is illustrated in FIG. 1. The program works in cooperation with a manufacturing facility 10 that produces the items corresponding to the targeted waste materials. The manufacturing facility 10 will add a precious metal, such as gold, silver, platinum or palladium, to the paper, glass or plastic materials used to manufacture the targeted items. The targeted items would be those that do not contain precious metals (i.e., that do not contain precious metals in a quantity or concentration that would justify attempts to reclaim the precious metals after the items are discarded). The targeted items will generally be those that have the greatest environmental impact on landfills, or items that are prone to being discarded as litter.

A visual marking is placed on the manufactured items to distinguish the targed items from other waste items that do not contain a precious metal. The manufactured items 11 with precious metals incorporated are then distributed to consumers through normal retail distribution channels 12. A monetary deposit is collected from consumers when the target items are purchased at the retail store.

After the target items have been used by the consumer, the consumer's household waste 13 is divided into a first portion for recycling and a second portion for conventional waste disposal. The second portion can be picked up by a waste disposal truck 14 and delivered to a collection point 15 and landfill 16 for conventional waste disposal.

The targeted waste material is delivered by the consumer to a recycling collection point 17. At the collection point 17, the monetary deposit is returned to the consumer upon delivery of the target waste material. The collected target waste material 18 is then processed to reclaim the precious metal content, or it is used by the manufacturing facility 10 to make new products containing precious metal.

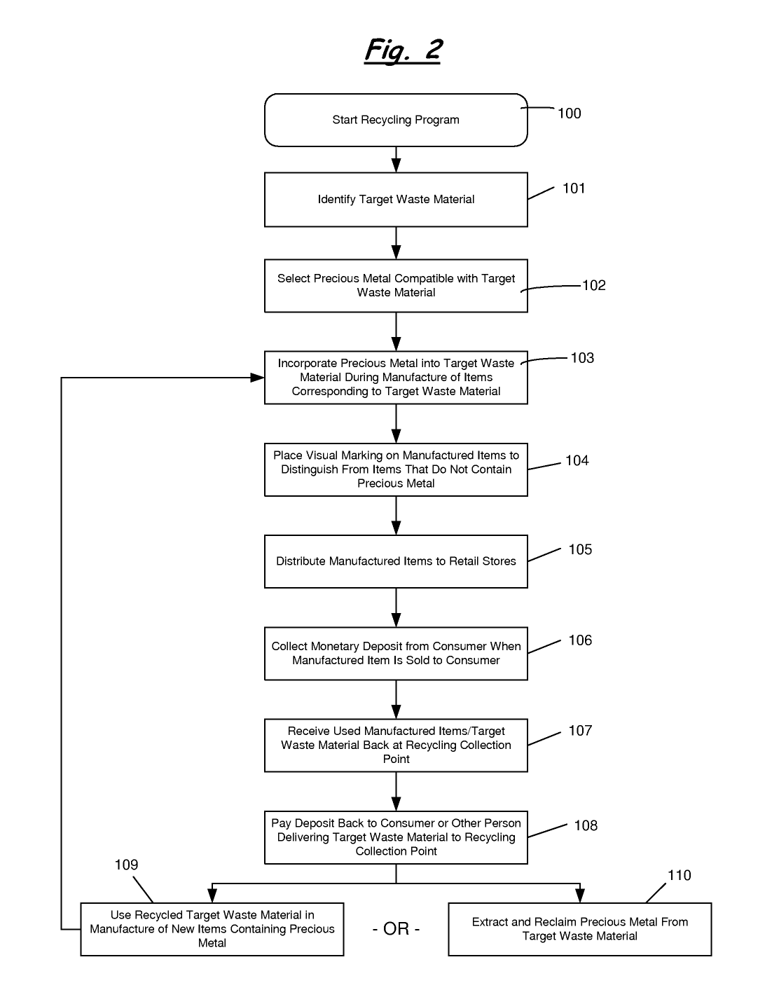

FIG. 2 summarizes the process of the present invention, as described above. The recycling program is started at step 100. A target waste material is identified in step 101. A precious metal compatible with the target waste material is selected in step 102. In step 103, the precious metal is incorporated into the target waste material during manufacture of the items corresponding to the target waste material. A visual marking is placed on the manufactured items in step 104 to distinguish the target items from those that do not contain precious metal.

The manufactured items are then distributed to retail stores in step 105. In step 106, a monetary deposit is collected from consumers when the manufactured items are sold at the retail level.

After the manufactured items are used, the consumer or another person delivers the used items (i.e., the target waste material) to a recycling collection point in step 107. The deposit is then paid back to the consumer or the other person delivering the target waste material in step 108. The target waste material is then either reused in the manufacture of new items containing precious metal in step 109, or processed to extract and reclaim the precious metal in step 110.

Conventional recycling efforts often fail to meet the expectations of the participants due to a lack of financial incentives to encourage the recycling. The present invention is based on the premise that recycling can be made more successful by providing better financial incentives for the recycling. By giving the waste and debris a value high enough, the participants in the program will find it more worthwhile to put forth the effort required to pick up the waste and debris or to never throw it away, and instead, sell the waste and debris to a recycling center.

The present invention enhances the value of targeted waste materials by incorporating within the waste materials precise amounts of precious metals during manufacture of the targeted items. The precious metals can be, for example, gold, silver, platinum, and/or palladium. Depending on the target waste material to be considered, there are a number of suitable methods for incorporating the precious metal for each type of waste.

For newspaper, cardboard, and other paper products, sponge gold (which is a soft powdery form of pure gold in which the gold atoms are very loosely bonded to each other) would be a suitable choice for the precious metal. Sponge gold is readily available commercially from various companies dealing with precious metals. The sponge gold could easily be mixed into the paper pulp at the factory level where the pulp is processed, press rolled and dried into blank newspaper rolls, cardboard, and other paper products.

Each batch of pulp used in the paper manufacturing process would need to be analyzed and tested to determine if the gold content is correct, adding more pulp or adding more sponge gold if necessary, then remixing the batch. Sponge gold will break down into very small pieces near the size of the molecule itself, and be evenly suspended within the watery paper pulp mix. In one embodiment, the ratio of the mix is approximately one part of sponge gold per 100,000 parts of the pulp mix by weight. For example, a ton of newspaper would have approximately one-third troy ounce of gold molecularly distributed evenly within the paper. Therefore, when the market price of gold is $700 an ounce, the recycle value of the paper would be approximately $0.11 per pound.

For glass, a similar process can be used. When the glass is in its molten state, just prior to forming it into the shape of bottles or other manufactured items, a precious metal, such as sponge gold, can be mixed into the molten glass solution.

For plastic, a similar process can be used. When the plastic material is in a hot melted state, or before the plastic material has solidified from a chemical reaction, a precious metal, such as sponge gold, can be mixed into the plastic material. This can be done prior to molding the plastic material into various shapes.

The ratio of the precious metal in plastic material can be higher than that contained in paper to reflect the fact that plastic waste is more harmful to the environment and requires much longer to biodegrade. For example, in one embodiment of the invention, a sufficient amount of precious metal can be incorporated into the plastic material to make it worth approximately $0.50 per pound.

The amount of precious metal contained in items of paper, glass, and plastic is small enough so as not to affect the strength or integrity of the materials in the manufactured items. The amount is also low enough to make it inexpensive for production and high enough to give a value to the targeted waste material to encourage recycling.

When items of paper, plastic, and glass are returned to be recycled, the precious metals contained within the waste material need not be extracted and refined back out. The precious metal content in these targeted items can instead be reclaimed by recycling the items (i.e., the precious metal content can remain within the recycled items). As the targeted items are recycled and processed into new items, the precious metal content can be analyzed and adjusted as needed so the new items or containers would contain the correct amount of precious metal again.

The present invention can also be used to encourage recycling of cigarette butts with filters. Cigarette butts are commonly discarded in our society in ways that create debris in our streets and grounds. Virtually no incentives exist today for encouraging proper disposal of cigarette butts, and smokers often think that cigarette butts are too small to have any significant adverse effects on the environment. However, the accumulated effect of many smokers discarding their cigarette butts as litter is a significant problem.

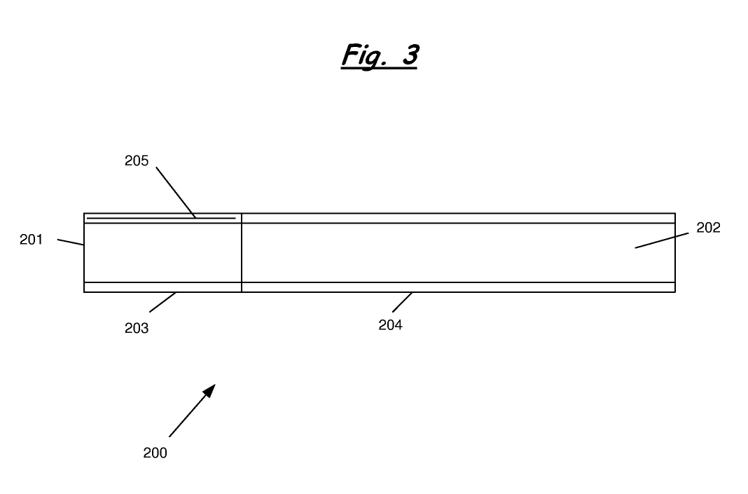

A modified cigarette 200 according to the present invention is shown in FIG. 3. The illustrated cigarette 200 includes a filter 201 at a butt end, a tobacco pack 202 at the other end, a paper 203 wrapped around the filter, and a paper 204 wrapped around the tobacco pack. The paper 203 at the butt end can be bonded to the external surface of the filter 201 to help maintain the integrity of the cigarette 200.

The cigarette 200 is modified to include a thin wire 205 bonded between the external surface of the filter 201 and the paper wrapping 203 during manufacture of the cigarette 200. The wire 205 can be made of a precious metal, such as gold, silver, platinum, or palladium, or compositions thereof. The cigarette 200 can be smoked in a normal fashion, and the butt remaining after smoking will contain the precious metal wire 205 embedded therein to encourage proper disposal.

In one embodiment, the wire 205 incorporated into the cigarette 200 has a small diameter or gauge size, such as approximately 0.0001″ to 0.0005″, and extends substantially the full length of the filter 201. The particular diameter of the wire 205 used at any given point in time would depend on what precious metal is used and the current market price of that metal. For example, a precious metal wire 205 having a value of approximately $0.05 to $0.10 per cigarette 200 could be used. With a recycling value like that, a monetary incentive would exist that would likely cause most all cigarette butts to be recycled.

In another embodiment, a thin gold leaf foil could be incorporated into the cigarette during manufacture to completely surround the filter. The foil could be located between the filter and the paper wrapping of the cigarette butt.

Realizing that cigarette filters are not reused again to create new filters, the reclaimed cigarette butts could be destroyed in a process where only the precious metals contained within them are extracted and refined to a sufficiently pure assay for reuse or resale. Precious metal refining companies currently exist that would purchase scrap cigarette butts containing precious metal and process the precious metal out of them using equipment and processes that already exist within that industry.

The technology and methods of the present invention could be used for (but are not limited to) encouraging recycling of the following types of targeted waste materials:

### Paper Products

Newspapers
Cardboard
Magazines
Phone Directories
Paper Shopping Sacks
Paper Containers

### Plastic Products

Plastic Beverage Containers
Plastic Food Containers
Plastic Children's Toys
Plastic DVD and VCR Storage Cases
Plastic Automotive Parts
Plastic Outer Coverings used for electronic components and tools (e.g., televisions, computers, stereos, VCR and DVD players, clock radios, microwave ovens, vacuum cleaners, hand drills, and circular saws)
Plastic Kitchen Items
Plastic Shopping Bags

### Glass Products

Glass Beverage Containers
Glass Food Containers

### Other Products

Cigarette Filters
Styrofoam Products and Containers

When used in food containers, beverage containers, cigarette butts, children's plastic toys, and various other items, there will be at least limited human contact with the precious metals. However, the Applicant does not believe the present invention will create any significant health and safety concerns as a result of such human contact with the precious metals. There is much scientific documentation regarding these issues.

For example, it is widely known that gold is non-reactive with most everything on earth. There are trace amounts of gold in our body right now (100 parts per billion by weight), in our sea water (0.05 parts per billion by weight), in our fresh water (0.002 parts per billion by weight), and in our food. The Applicant is not aware of any therapeutic value of gold within our body or any harmful affects of any kind.

Various silver compounds have been used in the medical profession for many decades. Silver has an ability to destroy microorganisms and bacteria. Silver is in sea water (0.05 parts per billion by weight) and in fresh water (0.03 parts per billion by weight).

Palladium chloride was formally prescribed as a treatment for tuberculosis at a rate of 0.065 grams per day without too many negative side effects. Palladium is also used in dental crowns and surgical instruments. In jewelry, white gold is actually an alloy of gold and palladium. Platinum is also used in jewelry. For investors, one ounce coins are minted in gold, silver, palladium and platinum, with a purity of 0.999 fine (the industry standard for precious metals).

The consumer or purchaser of the items that use the technology of the present invention can be required to pay for the precious metal within the items at the time of purchase. This payment will be in the form of an added deposit fee, which the consumer can recuperate upon returning and selling the waste items to a recycling collection point (e.g., a recycling company).

The items that use the technology of the present invention will need to be distinguishable from other items that do not contain precious metals. A special printed logo or other visual marking can be printed on the precious metal-containing items to distinguish the target items from other items. The visual marking will help identify the target items during a transitional period when some items contain precious metals and some do not.

Most items mentioned above will be weighed when returned for recycling, and the deposit amount paid back. Some items may have to be returned on a physical count basis. Since the price of precious metals varies according to changing market conditions, the deposit amount and/or the precious metal content can be changed as necessary. For example, the deposit amount can stay the same and the precious metal content can fluctuate according to changing market conditions. Alternatively, the precious metal content can stay the same and the deposit can fluctuate. Each participating industry can choose which works best for their needs.

The present invention will provide the monetary incentives needed to encourage efforts by consumers, as well as cities and counties, to have successful recycling programs to reduce our society's overuse and reliance on landfills and other waste disposal habits that harm our environment.

While the invention has been specifically described in connection with specific embodiments thereof, it is to be understood that this is by way of illustration and not of limitation, and the scope of the appended claims should be construed as broadly as the prior art will permit.

What is claimed is:

1. A smokable cigarette for use in a recycling program, comprising:
a filter wrapped with paper to form a butt portion of the cigarette;
a tobacco pack wrapped with paper connected to the butt portion; and
a precious metal contained within the butt portion to provide an incentive for proper disposal of the butt portion to reclaim the precious metal.

2. The cigarette according to claim 1, wherein said precious metal contained within the butt portion does not provide a useful function in said cigarette other than to provide said incentive for proper disposal.

3. The cigarette according to claim 1, wherein said precious metal comprises a wire bonded between an external surface of the filter and the paper wrapped around the filter.

4. The cigarette according to claim 1, wherein said precious metal comprises a leaf foil surrounding the filter and located between the filter and the paper wrapped around the filter.

5. The cigarette according to claim 1, wherein said butt portion comprises a visual marking to distinguish from cigarette butts that do not have precious metal therein.

6. The cigarette according to claim 1, wherein said precious metal is selected from the group consisting of: gold, silver, platinum, palladium and compositions thereof.

7. A plastic product for use in a recycling program, comprising:
a molded plastic material targeted for recycling;
a precious metal contained within said molded plastic material to provide an incentive for proper disposal of the plastic product to reclaim the precious metal, wherein said precious metal contained within said plastic material does not provide a useful function in said plastic product other than to serve as an incentive for proper disposal of the plastic product.

8. The plastic product according to claim 7, wherein said precious metal is mixed into plastic material before the plastic material has solidified during manufacture of the plastic product.

9. The plastic product according to claim 7, wherein said precious metal is sponge gold.

10. The plastic product according to claim 7, wherein said plastic product comprises a visual marking to distinguish from other plastic products that do not have precious metal therein.

11. The plastic product according to claim 7, wherein said precious metal is selected from the group consisting of: gold, silver, platinum, palladium and compositions thereof.

12. A manufactured article for use in a recycling program, comprising:
a first material targeted for recycling; and
a precious metal mixed into said first material to provide an incentive for proper disposal of the manufactured article to reclaim the precious metal, wherein said precious metal contained within said manufactured article does not provide a useful function in said manufactured article other than to serve as an incentive for proper disposal of the manufactured article.

13. The manufactured article according to claim 12, wherein said first material is a paper product.

14. The manufactured article according to claim 13, wherein said precious metal is mixed into pulp during manufacture of the paper product.

15. The manufactured article according to claim 14, wherein said precious metal is sponge gold.

16. The manufactured article according to claim 12, wherein said first material is a glass product.

17. The manufactured article according to claim 16, wherein said precious metal is mixed into molten glass during manufacture of the glass product.

18. The manufactured article according to claim 17, wherein said precious metal is sponge gold.

19. The manufactured article according to claim 12, wherein said manufactured article comprises a visual marking to distinguish from other manufactured articles that do not have precious metal therein.

20. The manufactured article according to claim 12, wherein said precious metal is selected from the group consisting of: gold, silver, platinum, palladium and compositions thereof.
